(19) United States
(12) Patent Application Publication
(10) Pub. No.: US 2005/0072038 A1
(43) Pub. Date: Apr. 7, 2005

(54) Fishing tackle device

(76) Inventor: Leigh Robert Daley, Meringa (AU)

Correspondence Address: DILWORTH & BARRESE, LLP, 333 EARLE OVINGTON BLVD., UNIONDALE, NY, 11553, US

(21) Appl. No.: 10/956,996

(22) Filed: Oct. 1, 2004

(30) Foreign Application Priority Data
Oct. 1, 2003 (AU) 2003905343
Oct. 28, 2003 (AU) 2003905918

(51) Int. Cl. A01K 83/06; A01K 85/00

(52) U.S. Cl. 43/44.2; 43/44.4

(57) ABSTRACT

A fishing tackle device comprising a body which has a head and a tail and a valley located on a top side of the tail. The fishing tackle device further comprises one or more fingers protruding outwardly from the valley. A bait fish is able to be positioned on said valley such that the fingers are embedded within the baitfish and securely locate the baitfish on the valley.

### FIELD OF THE INVENTION

This invention relates to a fishing tackle device. In particular, although not exclusively, the invention relates to a fishing tackle device adapted to secure bait fish thereon for trolling. It will be appreciated that that other forms of bait may be located on the fishing tackle device of the present invention.

### BACKGROUND TO THE INVENTION

Trolling with baitfish is a popular form of fishing. In particular, trolling is the fishing method of choice when anglers are fishing for game fish. Trolling from a boat involves fishing by trailing a baited line behind the boat while the boat is moving. Optionally, a line with a lure attached may be trailed behind the boat.

When trolling with baitfish it is important that fish is rigged such that it maintains an upright position and mimics the motion of a fish swimming. There are special ways in which the hook(s) and line can be rigged around the baitfish such that the baitfish moves through the water in an upright position and mimics the motion of a swimming baitfish. However, it requires a large amount of skill and experience to correctly rig a baitfish in this way. Additionally, it requires a large amount of time to correctly rig a baitfish. If a baitfish is not rigged in a correct manner it tends to spin during trolling and this reduces its attractiveness to predatory fish that are being targeted.

There have been devices developed to assist in quickly rigging baitfish so that the baitfish does not spin during trolling and is orientated to mimic a live swimming baitfish. One such device is known in the art as a bait holder and is formed from plastic or metal.

Bait holder devices are embodied in different forms with the most common having a cavity in which the head of the baitfish is completely inserted. One or more hooks arranged in a gang hook configuration, as is known in the art, are attached to the trailing end of the chin guard for insertion within the attached fish. The bait holder has an eyelet on the leading edge for attachment to a fishing line.

The disadvantage of this embodiment of the bait holder is that baitfish come in a wide variety of shapes and sizes and the cavity in which the head of the bait fish is inserted may not be large enough or may be too large and hence does not appropriately accommodate the head of the baitfish. This results in the baitfish spinning while being trolled which is not a desirable action.

U.S. Pat. No. 6,658,785 discloses a lure for mounting bait fish which includes a unitary weighted body having a socket for receiving the nose of the bait fish and a lower tail section having inwardly projecting hooks for penetrating the sides of the bait fish whilst mounted on the lower.

The socket of the lure U.S. Pat. No. 6,658,785 is enclosed and hence this lure is not capable of being used to effectively troll bait fish of difference sizes and types. The heads of larger bait fish are not able to be effectively secured within the socket of the lure disclosed in this patent and hence the bait fish spins whilst being trolled. This action is undesirable as it does not mimic the action of a live bait fish and hence the success of this lure is reduced.

### OBJECT OF THE INVENTION

The object of the invention is to overcome or at least alleviate one or more of the above problems and/or provide the consumer with a useful or commercial choice.

### DISCLOSURE OF THE INVENTION

In one form, although it need not be the only or indeed the broadest form, the invention resides in a fishing tackle device comprising:
a body having a head and a tail;
a valley located on a side of said tail, said valley having opposing open ends; and
one or more fingers, said one or more fingers protruding outwardly from said tail;
wherein a bait fish is able to be located on said valley such that said fingers are embedded within said baitfish.

Further features of the present invention will become apparent from the following detailed description.

### BRIEF DESCRIPTION OF THE DRAWINGS

To assist in understanding the invention and to enable a person skilled in the art to put the invention into practical effect, a preferred embodiment of the invention will be described by way of example only with reference to the accompanying drawings, wherein:

FIG. 1 shows a side view of a fishing tackle device according to a first embodiment of the present invention;

FIG. 2 shows an end view of the fishing tackle device shown in FIG. 1;

FIG. 3 shows the fishing tackle device shown in FIG. 1 attached to a fishing line and having a baitfish located thereon;

FIG. 4 shows a side view of a fishing tackle device according to a second embodiment of the present invention;

FIG. 5 shows a side view of a fishing tackle device according to a further embodiment of the present invention.

### DETAILED DESCRIPTION OF THE INVENTION

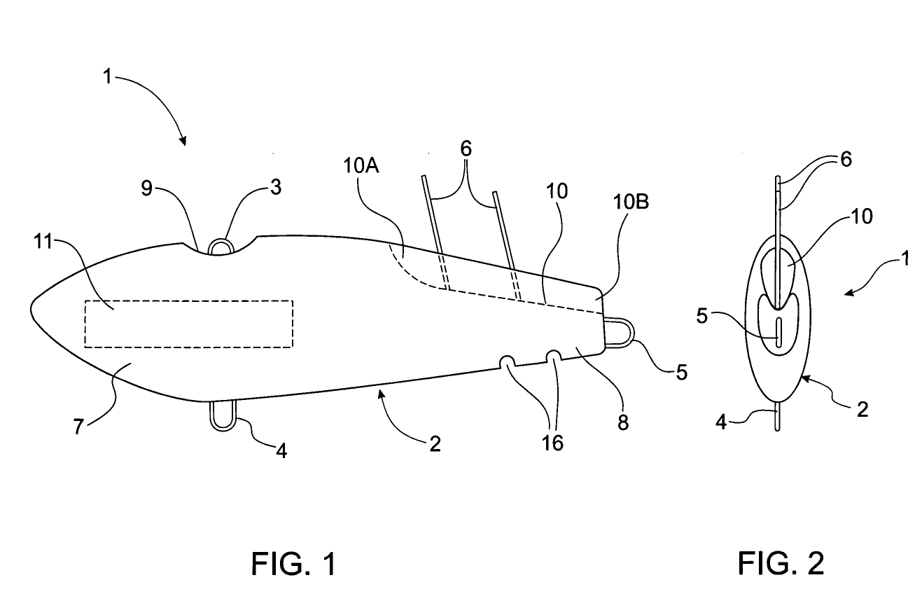

FIG. 1 and FIG. 2 shows a fishing tackle device 1 according to an embodiment of the present invention. Fishing tackle device 1 has a torpedo shaped body 2, eyelets 3-5 and fingers 6 protruding from the body 2.

Body 2 is generally torpedo shaped and has a head 7 at one end and a tail 8 at an end distal from head 7. Preferably, tail 8 is tapered at end distal from head 7. A recess 9 is located on an upper side of head 7. An attachment member in the form of an eyelet 3 extends outwardly from within recess 9. An attachment member in the form of an eyelet 4 is located on an underside of head 7 as shown. A weighted portion in the form of weight 11 (shown in shadow in FIG. 1) is embedded within head 7 and is formed preferably from lead. Optionally, weight 11 may be formed from a different type of metal or another type of dense material.

Alternatively, in an optional embodiment the weight 11 may be omitted and head 7 may be formed from a more dense material than tail 8 and hence is heavier than tail 8.

A valley 10 is located on a topside of the tail 8. Valley 10 has opposing open ends 10A and 10B such that no portion of valley 10 is enclosed. A pair of fingers 6 extend outwardly from within valley 10 of tail 8. Optionally, fingers 6 may each have a barb located at their end. An attachment member in the form of an eyelet 5 protrudes backwardly from tail 8 below valley 10. Optionally, eyelet 5 may extend downwardly from tail 8. A pair of grooves 16 are located on an underside of tail 8. Optionally, more than two grooves may be located on an underside of tail 8.

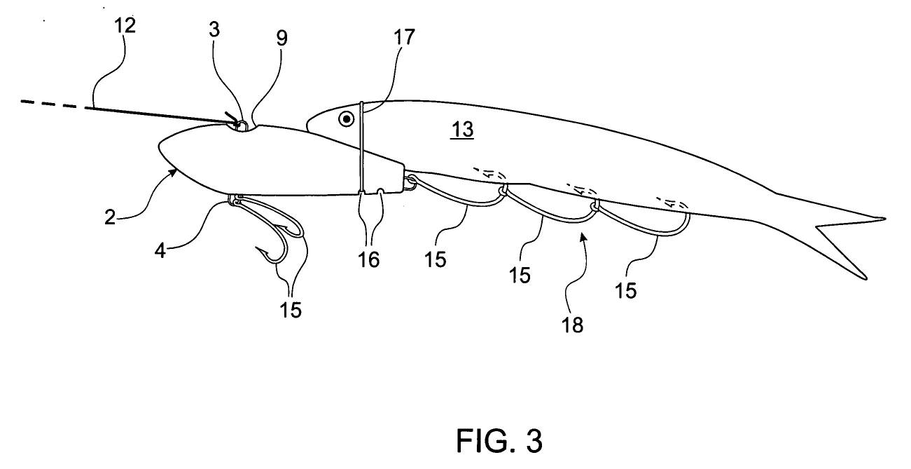

FIG. 3 shows fishing tackle device 1 attached to a fishing line 12 for trolling. In use, a baitfish 13 is securely fastened to fishing tackle device 1 by locating the baitfish 13 on valley 10 such that fingers 6 are embedded within the baitfish 13.

A gang hook 18 is attached to eyelet 5 and is comprised of a plurality of hooks 15 interlocked as is known in the art. Hooks 15 are embedded within the underside of baitfish 13 and assist in holding baitfish 13 in place and for hooking fish that may attack the baitfish 13. Additionally, a resilient attachment member such as an elastic band 17 is fitted around baitfish 13 to facilitate keeping baitfish 13 firmly embedded on fingers 6. Elastic band 17 is located upon one of groove 16 on the underside of tail 8. Optionally, a second elastic band may be fitted around the second groove 16. Other devices may be used to help secure the baitfish such as cable ties, zip ties or the like.

Optionally, hooks 15 may not be embedded within the underside of bait 13 but may be fastened to a side of bait fish 13 by means of a rubber band, string or the like.

Fishing tackle device 1 is attached to fishing line 12 by fastening line 12 to eyelet 3. Line 12 may be fastened to eyelet 3 by means of a blood knot, a different knot suitable for fishing or by means of a wire trace as is known in the art. Alternatively, line 12 may be fastened to eyelet 3 by means of a swivel or a snap swivel or a snap clip.

It will be appreciated that line 12 is connected to a fishing rod located on a moving boat and fishing tackle device 1 is being trailed behind the boat. Alternatively, fishing line 12 is connected to a fishing rod located on land and trolling is facilitated by the fisherperson continuously casting and winding in fishing tackle device 1.

As hooks 15 of gang hook 18 are embedded within the underbelly of baitfish 13 and fingers 6 are embedded with it's head, the baitfish remains upright and does not rotate while being trolled. Furthermore, valley 10 ensures that the baitfish 13 is correctly orientated and does not spin and resembles a swimming fish during trolling.

Additionally, as eyelet 3 is located within recess 9 the attachment of fishing line 12 occurs in such a way that minimizes the twisting forces on baitfish 13 and results in baitfish 13 mimicking the action of a swimming fish. Furthermore, the torpedo shape of the body 2 and the lead weight 11 positioned within the head 7 help orientate the baitfish 13 such that the baitfish 13 mimics the motion of a swimming fish while being trolled.

Fishing tackle device 1 is colored so that it attracts fish. Hence, the function of fishing tackle device 1 is not only to ensure that the baitfish 13 is correctly orientated during trolling but also to act as an attractant to fish. As such, hooks 15 attached to eyelet 4 are present in the event that a predatory fish attempts to attack the fishing tackle device 1 instead of the baitfish 13.

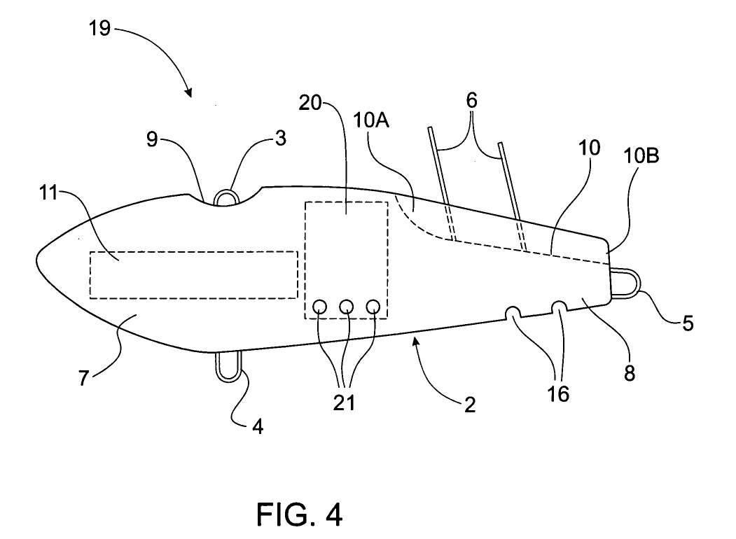

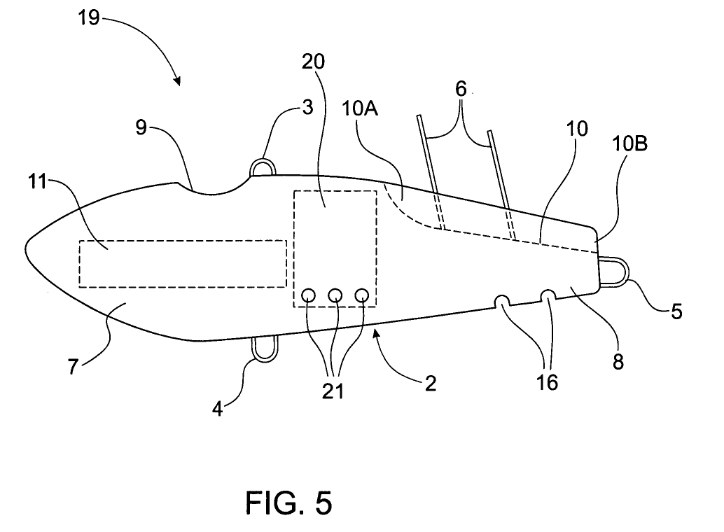

FIG. 4 shows a side view of fishing tackle device 19 according to a second embodiment of the present invention. Fishing tackle device 19 retains all features described above for fishing tackle device 1 but includes a cavity 20 located within body 2. A plurality of rattle elements in the form of ball bearings 21 are present within cavity 20. It will be appreciated that other rattle elements may be used such as bells, sand and the like.

In use, the ball bearings 21 create a rattling sound due to the movement of fishing tackle device 19 through the water. This rattling sound is an attractant for fish and increases the prospects of catching a fish using fishing tackle device 19.

It will be appreciated that ball bearings 21 may be replaced with bells or other small hard objects. Alternatively, an electrical sound device may be inserted within cavity 20 to create a suitable sound for attracting fish. It will be appreciated that cavity 20 may be located at any position within fishing tackle device 19. Alternatively, fishing tackle device 19 may be hollow.

FIG. 5 shows a side view of fishing tackle device 19 according to a further embodiment of the present invention. The embodiment of fishing tackle device 19 shown in FIG. 5 has eyelet 3 moved rearwardly from recess 9. This placement further adds to the trolling characteristics of the fishing tackle device of the present invention as when a fishing line is connected to eyelet 3 there contact between the line and the body 2 is reduced. Additionally, eyelet 4 is moved rearwardly in FIG. 5 from previous embodiments of the fishing tackle device of the present invention.

It will be appreciated that the movement of eyelets 3 and 4 rearwardly on body 2 as shown in FIG. 5 may be applied to the embodiment of the fishing tackle device shown in FIG. 1.

Fishing tackle device of the present invention offers significant advantage over prior art devices in that it provides a quick and simple way to rig a baitfish for trolling such that the baitfish does not spin and mimics the motion of a swimming fish. Furthermore, fishing tackle device of the present invention acts as an attractant to fish and may be used to troll without any baitfish secured to it in the same way that a lure is used to catch fish.

Furthermore, the fishing tackle device of the present invention is able to effectively accommodate a range of different shapes and sizes of bait fish as the bait fish are located on an open ended valley on the tail of the fishing tackle device. Hence, the fishing tackle device of the present invention can be used to troll with a wide variety of bait fish and the bait fish exhibit a natural swimming action whilst being trolled. This is in contrast with prior art devices wherein the nose of bait fish are accommodated in a closed cavity of the fishing tackle devices and hence these fishing tackle devices are not adaptable to accommodate a range of bait fish.

Throughout the specification the aim has been to describe the invention without limiting the invention to any one embodiment or specific collection of features. Persons skilled in the relevant art may realize variations from the specific embodiments that will nonetheless fall within the scope of the invention.

For example, eyelets 3-5 may instead be swivels embedded within the fishing tackle device of the present invention. Furthermore, the fishing tackle device of the present invention may have a completely hollow body and weight 11 may be positioned within the hollow body.

It will be appreciated that various other changes and modifications may be made to the embodiment described without departing from the spirit and scope of the invention.

1. A fishing tackle device comprising:
a body having a head and a tail;
a valley located on a side of said tail, said valley having opposing open ends; and
one or more fingers, said one or more fingers protruding outwardly from said tail;
wherein a bait fish is able to be located on said valley such that said fingers are embedded within said baitfish.

2. The fishing tackle device of claim 1, wherein said head is heavier than said tail.

3. The fishing tackle device of claim 2, wherein a weighted portion is located within said head.

4. The fishing tackle device of claim 2, wherein said head is formed from a first material and said tail is formed from a second material with said first material being more dense than said second material.

5. The fishing tackle device of claim 1, wherein said tail is tapered to an end distal to said head.

6. The fishing tackle device of claim 1, wherein one or more attachment members are located on said body.

7. The fishing tackle device of claim 6, wherein said attachment members are eyelets.

8. The fishing tackle device of claim 1, wherein said valley is located on a top side of said tail.

9. The fishing tackle device of claim 1, wherein an enclosed cavity is located within said body.

10. The fishing tackle device of claim 9, wherein said cavity contains a plurality of rattle elements, said rattle elements creating a noise whilst said fishing tackle device is undergoing movement.

11. The fishing tackle device of claim 10, wherein said rattle elements are ball bearings.

12. The fishing tackle device of claim 1, wherein at least one groove is located on an underside of said tail.

13. The fishing tackle device of claim 12, wherein said at least one groove co-operates with a resilient attachment member in order to securely locate said bait fish on said valley.

14. The fishing tackle device of claim 13, wherein said resilient member is an elastic band.
